(19) United States
(12) Patent Application Publication
(10) Pub. No.: US 2016/0053948 A1
(43) Pub. Date: Feb. 25, 2016

(54) LED Lighting Apparatus

(71) Applicant: CLEDOS green tech Limited, Hong Kong (HK)

(72) Inventors: James Wang, Hong Kong (HK); Kei May Lau, Hong Kong (HK); Parco Wang, Hong Kong (HK); Terence Cho, Hong Kong (HK); Zhaojun Liu, Hong Kong (HK); Eddie Chong, Hong Kong (HK)

(21) Appl. No.: 14/464,669

(22) Filed: Aug. 20, 2014

(51) Int. Cl. F21K 99/00; F21V 23/00; F21V 23/06; F21S 4/00; F21V 3/04

(52) U.S. Cl. CPC F21K 9/56; F21S 4/008; F21V 3/0418; F21V 23/06; F21V 23/003; F21Y 2101/02

(57) ABSTRACT

A light emitting diode (“LED”) lighting apparatus has several components for providing lighting including a boost circuit for driving a plurality of LED strips. The boost circuit is used to boost an input voltage to a predefined voltage, where the predefined voltage is greater than the input voltage. Each of the LED strips has a set of serially-connected LEDs coupled to a transparent backing. The sets of LEDs are serially connected to each other. The predefined voltage is applied to the strips via the serial connection to drive the LEDs of the strips.

### FIELD OF INVENTION

The disclosure relates to methods, systems, and apparatuses for lighting, and, more particularly, to methods, systems, and apparatuses for lighting using light emitting diodes.

### BACKGROUND

Light emitting diodes (“LEDs”) are relatively inexpensive lighting sources given their lifespan of one to two decades. In addition, LEDs also have low energy consumption, small sizes, fast switching, and great durability and reliability when compared to traditional light sources (e.g., incandescent light bulbs, fluorescent light bulbs, etc.). Depending on the composition of the LEDs, the LEDs can be made to emit light in various colors in the visible light spectrum, except for a pure white light.

In order to simulate white light, LED manufacturers typically use the following methods. A first method utilizes three LEDs having different colors, e.g., red, green, and blue (“RGB”). Mixing the color output from these three LEDs can simulate a white-colored light to be produced. However, color mixing of three separate LEDs is not a simple process to guarantee a blended and evenly mixed white light color, and is typically very complicated.

Another problem with the RGB LED method is that it is hard to account for the variations that occur between individually-colored LEDs. While the color of the LED can be fairly characterized as being red, green, or blue, variations as between the different shades of red, green and blue can be great amongst LEDs of the similar color. For instance, one green LED can have a very different look that another green LED since their shades of green may be difficult. This variation can occur between different manufacturers of each LED and even occur between different batches of LEDs from the same manufacturer. This variation makes it difficult to produce a standard white-colored light since the same mixture of light from the RGB LEDs will produce different white lights.

A second method is to utilize a single blue LED with a phosphor coating to mix yellow light from the phosphor with blue light from the LED to produce white light. This method is simpler and cheaper than the RGB LED method since it involves only one LED as opposed to three separate LEDs and does not need to find the right color balance to generate a white light.

A single blue LED with an adjustable amount of phosphor coating can produce a more evenly mixed and blended white color. However, since a single LED is being used, the variations between the produced white lights are more pronounced than the RGB LED method. Without the ability to alter the different mixture of RGB LEDs, the single blue LED will have the same white color and cannot be adjusted after manufacturing to match another phosphor coated blue LED.

In producing white light with LEDs, it can be desirable to produce white light that mimics traditional lighting sources. For example, traditional lighting fixtures that are used in a typical home are usually incandescent lights. It might be desirable to use LEDs in place of an incandescent light bulb to gain the above mentioned benefits of using LEDs, yet retain the lighting effect of an incandescent light bulb.

Color temperature is a characteristic of visible light that has been used to describe the different colors produced in LEDs. Color temperature is conventionally stated in the unit of absolute temperature, the Kelvin, having the unit symbol K. Color temperatures over 5,000K are called cool colors (bluish white), while lower color temperatures (2,250-3,000 K) are called warm colors (yellowish white through red). For the various white colors, the temperature color can be used to describe the type of white light emitted. For example, a 2500 Kelvin white could be considered to be an approximation of an incandescent bulb while a 3400 Kelvin white could be considered to be the approximation of a halogen light.

In addition to a white color problem, LEDs often suffer from efficiency droop, which causes efficiencies of the LEDs to drop by as much as 20% when the LEDs are subjected to greater electrical currents. Such flaw has been a major obstacle to the development of LED lighting for households that call for economical sources of versatile and bright light. Several studies have found that the reason of the drop in efficiency is due to electron leakage where electrons collide with each other and lose their energy through heat instead of light. Thereby, household and commercial lighting applications, in which high currents are drawn, can lead to inefficient LEDs.

Therefore, it would be desirable to have an LED lighting apparatus that emits white light and that mimics the lighting effect of traditional lighting sources. In addition, it would be desirable to have an LED lighting apparatus that can be operated to reduce efficiency droop.

### SUMMARY OF INVENTION

Briefly, the disclosure relates to a light emitting diode (“LED”) lighting apparatus, comprising: a boost circuit for boosting an input voltage to a predefined voltage, wherein the predefined voltage is greater than the input voltage; a plurality of strips, wherein each of the strips has a set of serially-connected LEDs and a transparent backing; wherein the sets of LEDs of the strips are serially connected to each other, and wherein the predefined voltage is applied to the strips via the serial connection to drive the LEDs of the strips.

### DESCRIPTION OF THE DRAWINGS

The foregoing and other aspects of the disclosure can be better understood from the following detailed description of the embodiments when taken in conjunction with the accompanying drawings.

FIGS. 1a-1c illustrate examples of LED lighting apparatuses having one or more strips of LEDs.

FIG. 2 illustrates a side view of a strip of an LED lighting apparatus.

FIGS. 3a-3b illustrate top views of examples of a strip of an LED lighting apparatus.

FIG. 4 illustrates a top view of a strip of an LED lighting apparatus having a silicone wrapper with quantum dots disposed on the strip.

FIG. 5 illustrates a block diagram of a boost circuit driving several strips of an LED lighting apparatus.

FIG. 6 illustrates a top view of a base of an LED lighting apparatus having a boost circuit and serial connections for connecting the strips of the LED lighting apparatus.

### DETAILED DESCRIPTION OF THE EMBODIMENTS

In the following detailed description of the embodiments, reference is made to the accompanying drawings, which form a part hereof, and in which is shown by way of illustration of specific embodiments in which the disclosure may be practiced.

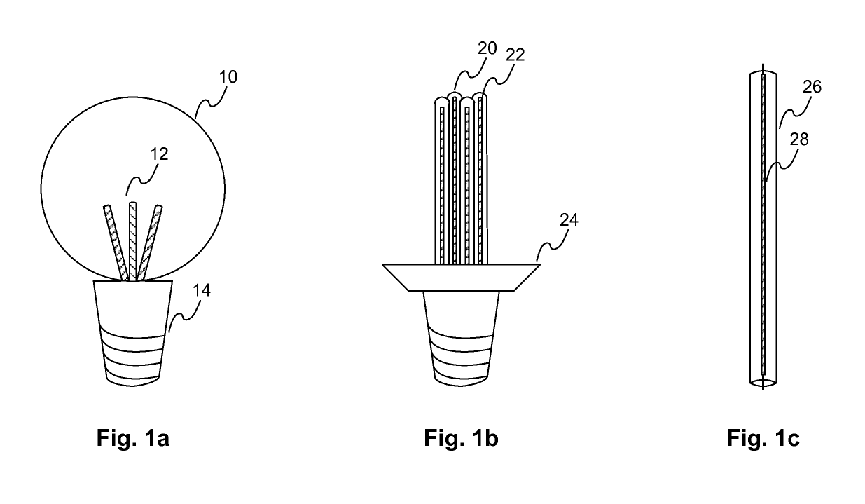

FIGS. 1a-1c illustrate examples of LED lighting apparatuses having one or more strips of LEDs. FIG. 1a illustrates an example of a light bulb. The light bulb comprises a spherical cover 10, light emitting diode (“LED”) strips 12, and a base 14. The spherical cover 10 is coupled to the base 14 to protect the LED strips 12 from damage. The spherical cover 10 is also transparent, and can be tinted to alter the color of the visible light emitted from the LED strips 12. In addition, the spherical cover 10 can be made of a polymer (e.g., plastic), glass, crystal, or other transparent material.

The LED strips 12 are also coupled to the base 14 such that the base can route an input voltage to the LED strips 12 to drive the respective LEDs of the LED strips 22. There can be three LED strips 12 positioned from the center of the base 14. The LED strips 12 can be further angled away from each other to provide varying lighting directions from the respective light bulb. For instance, each of the strips 12 can have LEDs disposed on the respective LED strip to direct light in one or more predefined directions. In this example, by having three LED strips, each of the strips can have LEDs substantially directed in at least three different directions. Furthermore, the backing of the LED strips 12 can be transparent such that the LEDs can also shine substantially in multiple directions from a single LED strip.

Each of the LED strips 12 has LEDs connected in series. The LED strips 12 are also serially connected such that all of the LEDs of the LED strips 12 are serially connected. A high input voltage can be applied to this serial connection for driving the LEDs of the LED strips 12 at high voltage and low current. By using a high voltage and low current to drive the LEDs, efficiency droop of the LEDs can be greatly reduced, allowing the LEDs to be driven more efficiently.

Although three LED strips 12 are illustrated in the present figure, it is understood that any number of LED strips can be implemented by a person having ordinary skill in the art based on the present disclosure. Each of the strips can have a number of LEDs as desired or needed by a particular lighting application. Thus, the present disclosure is meant to incorporate these various configurations as well.

FIG. 1b illustrates another example of a light bulb. The light bulb comprises tubular covers 20, LED strips 22, and a base 24. The tubular covers 20 are coupled to the base 24 to protect the LED strips 22 from damage. The tubular covers 20 are also transparent, and can be tinted to alter the color of the light emitted from the LED strips 22. In addition, the tubular covers 20 can be made of a polymer (e.g., plastic), glass, crystal, or other transparent material. The LED strips 22 are also coupled to the base 24 such that the base can route an input voltage to the LED strips 22 to drive the respective LEDs of the LED strips 22. The LED strips 22 can be positioned parallel to one another. Each of the strips 22 can have LEDs substantially directed in different directions. Furthermore, the backing of the LED strips 22 can be transparent such that the LEDs can also shine substantially in multiple directions from a single LED strip.

Each of the LED strips 22 has LEDs connected in series. The LED strips 22 are also serially connected such that all of the LEDs of the LED strips 12 are serially connected. A high input voltage can be applied to this serial connection for driving the LEDs of the LED strips 22 at high voltage and low current. By using a high voltage and low current to drive the LEDs, efficiency droop of the LEDs can be greatly reduced, allowing the LEDs to be driven more efficiently.

Although four LED strips 22 are illustrated in the present figure, it is understood that any number of LED strips can be implemented by a person having ordinary skill in the art based on the present disclosure. Each of the strips can also have a number of LEDs as desired or needed by a particular lighting application. Thus, the present disclosure is meant to incorporate these various configurations as well.

FIG. 1c illustrates yet another example of a light bulb. The light bulb comprises a single, tubular cover 26 and a single LED strip 28 within the tubular cover 26. The LED strip 28 is coupled to the cover 26. The tubular cover 26 can be transparent and also tinted to alter the color of the light emitted from the LED strip 28. In addition, the tubular cover 26 can be made of a polymer (e.g., plastic), glass, crystal, or other transparent material. An input voltage can be applied across the ends of the LED strip 28 to drive the respective LEDs. The strip 28 can have multiple LEDs substantially directed in different directions such that emitted light spreads from the light bulb omni-directionally. Furthermore, the backing of the LED strip 28 can be transparent such that the LEDs can also shine substantially in multiple directions (e.g., from a front face of the LEDs and a back face of the LEDs).

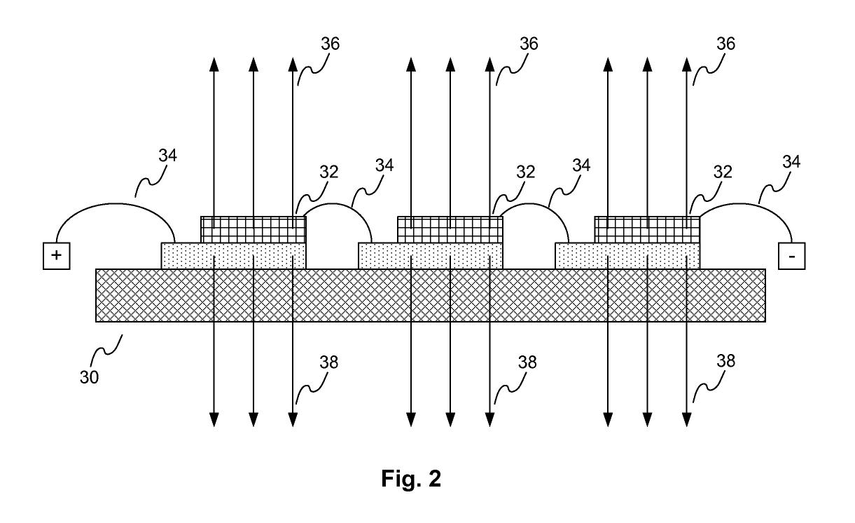

FIG. 2 illustrates a side view of a strip of an LED lighting apparatus. A strip of an LED lighting apparatus comprises a backing 30, multiple LEDs 32, and connectors 34. The backing 30 can be a transparent material, e.g., a polymer (e.g., plastic), glass, crystal, or other transparent material, to allow light from an LED on the strip to shine through the backing 30. The LEDs 32 can be coupled to a single side of the backing 30. The connectors 34 serially connect the LEDs 32 such that an input voltage can be applied across the strip to serially drive the LEDs 32. If a front side for the LEDs 32 is defined as the side opposite from the backing 30, the LEDs 32 can have light rays 36 emitted from the LEDs 32 on the front side. Also, if a back side for the LEDs 32 is defined as the side having the backing, then the LEDs 32 can have light rays 38 emitted from the LEDs 32 on the back side that penetrates the back side and travels through the backing 30 since the backing is transparent.

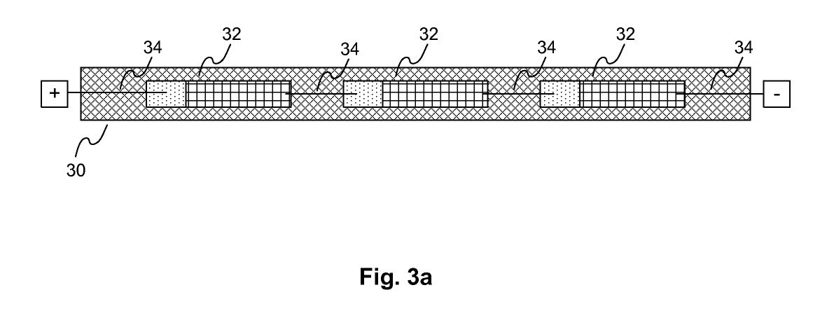

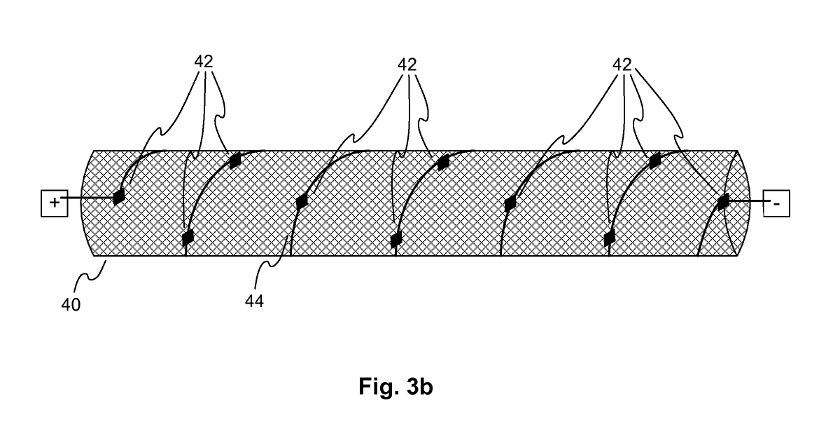

FIGS. 3a-3b illustrate examples of a strip of an LED lighting apparatus. In particular, FIG. 3a illustrates a top view of a strip of an LED lighting apparatus. In the top view, the front side of the LEDs 32 are visible as well as the connectors 34. The LEDs 32 are coupled to a single side of the backing 30 such that the LEDs 32 are aligned along a plane of that backing 30. However, it is understood by a person having ordinary skill in the art that the number of LEDs and the positions of the LEDs can be varied depending on the application and/or purpose of the respective light bulb.

FIG. 3b illustrates a side view of a strip of an LED lighting apparatus. A strip comprises a tubular backing 40, LEDs 42, and connectors 44 positioned along a spiral that runs along the tubular backing 40. The LEDs 42 and the connectors 44 are serially connected. An input voltage can be applied across that serial connection to drive the LEDs 42. Since the LEDs 42 are positioned on the tubular backing 40 along a spiral pattern about the tubular backing, light can be emitted from the strip omni-directionally. In an example, the LEDs 42 can be equidistance from each other along the spiral pattern.

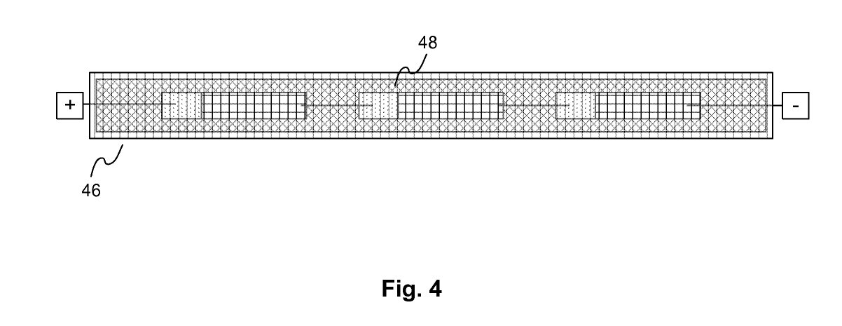

FIG. 4 illustrates a top view of a strip of an LED lighting apparatus having a silicone wrapper with quantum dots disposed on the strip. A strip 48 of an LED lighting apparatus can have a silicone wrapper 46 deposited around the strip 48 to change the color of the emitted light from the LEDs of the strip 48. The silicone wrapper 46 can be deposited onto the strip using various methods, including being printed on to the strip 48, e.g., using an inkjet, sputtered on, melted on, or otherwise deposited onto the strip 48. It is understood by a person having ordinary skill in the art that various methods for deposition of the silicone wrapper on the strip can be applied.

Typically, a blue-ish light (or other color depending on the materials of the LEDs) is emitted from the respective LEDs of the strip 48. The silicone wrapper 46 can have quantum dots, phosphorous, or other compound for altering the emitted color to a predefined color. For instance, yellow light may be more desirable, so phosphorous can be embedded in the silicone wrapper 46 to convert the emitted light from the LEDs to a more desirable color.

Existing LEDs can emit light in the ultraviolet (“UV”), visible, or infrared (“IR”) wavelength range. LEDs generally have narrow emission spectra, which mean LEDs cannot directly be used to produce white light. Phosphors can be introduced to convert a portion of the light originally emitted by the LED into light of a different wavelength. The combination of the converted light and the originally emitted light renders a more desirable output light. However, the white light converted by only one type of phosphor typically has a low color rendering index (“CRI”) and can only reach a limited range of color temperatures.

Quantum dots (also known as semiconductor nanocrystals) can be used to convert the light emitted by LEDs to generate light in the visible or infrared regions. Quantum dots are nanocrystals that have a diameter smaller than the bulk exciton Bohr radius. Due to the quantum confinement effects, the energy differences between electronic states of a quantum dot are a function of both the composition and the physical size of the quantum dot. Thus, the optical and optoelectronic properties of quantum dots can be tuned by changing the physical size of the quantum dots. The quantum dots absorb all wavelengths shorter than the absorption peak wavelength and emit light at a longer wavelength. The bandwidth of the quantum dot luminescent spectra is related to temperature dependent Doppler broadening, the Heisenberg Uncertainty Principle, and the size distribution of the quantum dots. For a given quantum dot, the emission band of the quantum dot can be controlled by adjusting the physical size of the quantum dot material. Thus, the quantum dot can produce a range of colors that are unattainable with conventional phosphors.

The silicone wrapper can comprise quantum dots embedded in the silicone wrapper that tune the color of the emitted light to a desirable color based on the diameter of the quantum dots. For an LED light bulb, the physical size of the quantum dots can be selected to obtain a predefined color for light emitted by the LED light bulb.

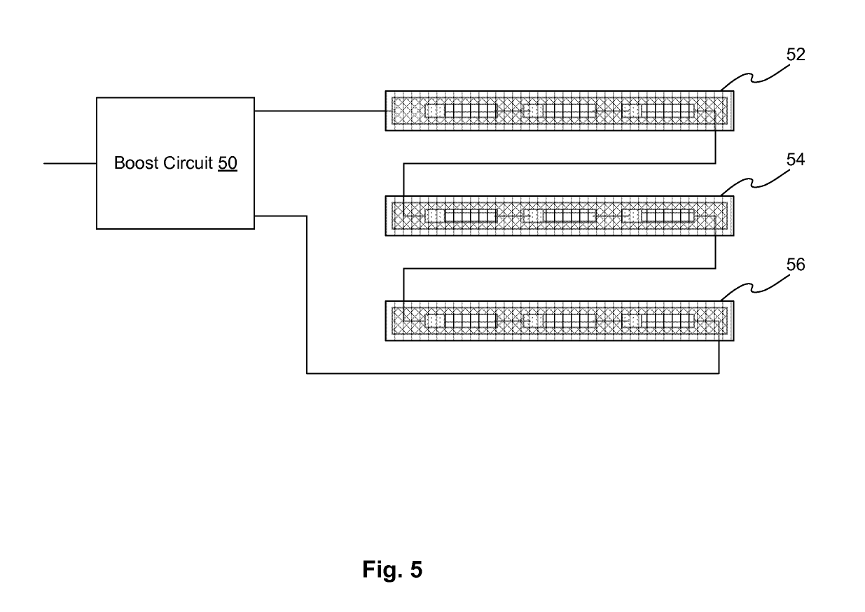

FIG. 5 illustrates a block diagram of a boost circuit driving several strips of an LED lighting apparatus. Typically, a home or commercial voltage supply can vary anywhere from 120V or more of alternating current. A boost circuit 50 can increase the voltage supply (or other input voltage) to a predefined voltage, e.g., from 120V to 300V or more. The predefined voltage is greater than the voltage supply. In order to use such a high voltage, strips 52-56 of an LED lighting apparatus are serially connected. In this manner, high voltage and low current can be used to drive the LED strips of the lighting device.

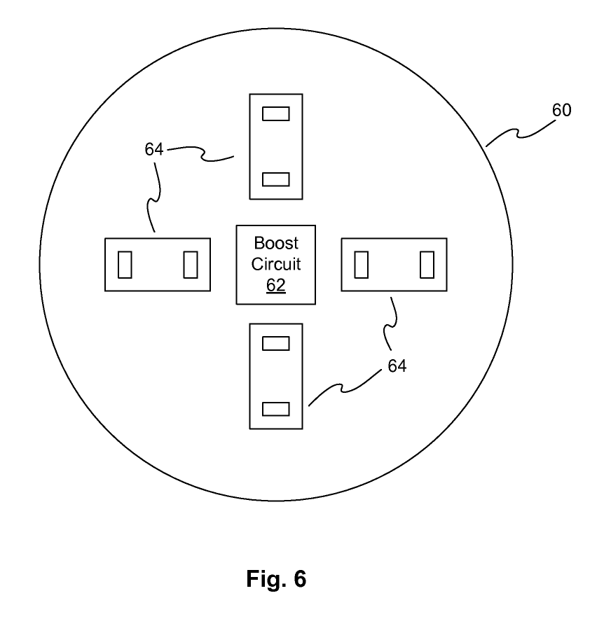

FIG. 6 illustrates a top view of a base of an LED lighting apparatus having a boost circuit and serial connections for connecting the strips of the LED lighting apparatus. The base of an LED lighting apparatus comprises an outer covering 60, a boost circuit 62 for receiving a voltage from the voltage supply and increasing the voltage supply to a predefined higher voltage, and strip connectors 64. The strip connectors 64 can be coupled to strips of the LED lighting apparatus to drive the predefined voltage across the serially connected strips. The connectors 64 can be connected serially such that the predefined voltage can be used to serially drive all of the LEDs of the LED strips.

While the disclosure has been described with reference to certain embodiments, it is to be understood that the disclosure is not limited to such embodiments. Rather, the disclosure should be understood and construed in its broadest meaning, as reflected by the following claims. Thus, these claims are to be understood as incorporating not only the apparatuses, methods, and systems described herein, but all those other and further alterations and modifications as would be apparent to those of ordinary skilled in the art.

We claim:

1. A light emitting diode (“LED”) lighting apparatus, comprising:
a boost circuit for boosting an input voltage to a predefined voltage, wherein the predefined voltage is greater than the input voltage; and
a plurality of strips, wherein each of the strips has a set of serially-connected LEDs and a transparent backing,
wherein the sets of LEDs of the strips are serially connected to each other, and
wherein the predefined voltage is applied to the strips via the serial connection to drive the LEDs of the strips.

2. The LED lighting apparatus of claim 1 wherein the backing of each of the strips comprises glass.

3. The LED lighting apparatus of claim 1 further comprising silicone wrappers, wherein each of the silicone wrappers is deposited on a certain one of the strips.

4. The LED lighting apparatus of claim 3 wherein the silicone wrappers comprises quantum dots.

5. The LED lighting apparatus of claim 4 wherein the physical size of the quantum dots is selected as a function of a predefined light color to be generated by the strips.

6. The LED lighting apparatus of claim 1 further comprising a base, wherein the base houses the boost circuit and a connector, wherein the plurality of strips are coupled to the base, wherein the connector serially connects the sets of LEDs of the strips, and wherein the predefined voltage is applied to the connector to drive the LEDs.

7. The LED lighting apparatus of claim 6 further comprising a cover, wherein the cover is coupled to the base, and wherein the cover encapsulates the strips.

8. The LED lighting apparatus of claim 6 further comprising a plurality of glass tubes, wherein the glass tubes are coupled to the base, and wherein each of the glass tubes encapsulates one of the strips.

9. The LED lighting apparatus of claim 1 wherein the backing of the strips are tubular in shape, and wherein the respective LEDs are disposed along a spiral pattern on the tubular shaped backing.

10. A light emitting diode (“LED”) lighting apparatus, comprising:
a boost circuit for boosting an input voltage to a predefined voltage, wherein the predefined voltage is greater than the input voltage;
a plurality of strips, wherein each of the strips has a set of serially-connected LEDs and a transparent glass backing; and
silicone wrappers,
wherein each of the silicone wrappers is deposited on a certain one of the strips,
wherein the sets of LEDs of the strips are serially connected to each other, and
wherein the predefined voltage is applied to the strips via the serial connection to drive the LEDs of the strips.

11. The LED lighting apparatus of claim 10 wherein the silicone wrappers comprises quantum dots.

12. The LED lighting apparatus of claim 11 wherein the physical size of the quantum dots is selected as a function of a predefined light color to be generated by the strips.

13. The LED lighting apparatus of claim 10 further comprising a base, wherein the base houses the boost circuit and a connector, wherein the plurality of strips are coupled to the base, wherein the connector serially connects the sets of LEDs of the strips, and wherein the predefined voltage is applied to the connector to drive the LEDs.

14. The LED lighting apparatus of claim 13 further comprising a cover, wherein the cover is coupled to the base, and wherein the cover encapsulates the strips.

15. The LED lighting apparatus of claim 13 further comprising a plurality of glass tubes, wherein the glass tubes are coupled to the base, and wherein each of the glass tubes encapsulates one of the strips.

16. The LED lighting apparatus of claim 10 wherein the backing of the strips are tubular in shape, and wherein the respective LEDs are disposed along a spiral pattern on the tubular shaped backing.

17. A light emitting diode (“LED”) lighting apparatus, comprising:
a boost circuit for boosting an input voltage to a predefined voltage, wherein the predefined voltage is greater than the input voltage;
a plurality of strips, wherein each of the strips has a set of serially-connected LEDs and a transparent glass backing;
silicone wrappers having quantum dots;
a base;
a cover; and
a plurality of glass tubes,
wherein each of the silicone wrappers is deposited on a certain one of the strips,
wherein the physical size of the quantum dots is selected as a function of a predefined light color to be generated by the strips,
wherein the sets of LEDs of the strips are serially connected to each other,
wherein the predefined voltage is applied to the strips via the serial connection to drive the LEDs of the strips,
wherein the base houses the boost circuit and a connector,
wherein the plurality of strips are coupled to the base,
wherein the connector serially connects the sets of LEDs of the strips,
wherein the predefined voltage is applied to the connector to drive the LEDs,
wherein the cover is coupled to the base,
wherein the cover encapsulates the strips,
wherein the glass tubes are coupled to the base,
wherein each of the glass tubes encapsulates one of the strips,
wherein the backing of the strips are tubular in shape, and
wherein the respective LEDs are disposed along a spiral pattern on the tubular shaped backing.
